(19) United States
(12) Patent Application Publication
(10) Pub. No.: US 2009/0285950 A1
(43) Pub. Date: Nov. 19, 2009

(54) Efficient food wraps

(76) Inventor: Robert G Baker, Boynton Beach, FL (US)

Correspondence Address: Robert G Baker, 4762 Palo Verde Drive, Boynton Beach, FL, 33436-2912, US

(21) Appl. No.: 12/154,115

(22) Filed: May 19, 2008

(51) Int. Cl. A21D 13/00

(52) U.S. Cl. 426/138

(57) ABSTRACT

A more-efficient edible food wrap eliminates the excess material of conventional wrap food products, providing effective containment while reducing the amount of raw materials used in production. Unused materials are thus available for additional production, extending quantities and thereby lowering producer costs. Easily fabricated on an automated or manual, multiple or individual basis, these improved structures provide easier assembly by hand or machine and selectable control of contained fluids. Further, these wrapper structures reduce collections of unconsumed food waster by including less of the often-discarded overlapped portions of wrap food products. These wrap designs are also applicable to egg rolls, pizza-like products, and other dough-based comestibles.

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING

Not Applicable

### BACKGROUND OF THE INVENTION

1. Field of the Invention

The present invention is generally related to the field of edible food wraps and more particularly to dough-based food wrap materials for handheld food products.

2. Prior Art

Many edible food wraps for both cold and hot temperature fillings are made from flour-based dough products. Examples of such food products are wrap sandwiches, fried spring rolls or egg rolls, tacos, and burritos.

Food wraps used for wrap sandwiches are usually made from a soft flour tortilla. Tortillas are typically made with ingredients of flour, salt, vegetable shortening, baking powder and water. Other tortilla recipes use corn as a primary constituent component. In the flour variations of such wraps, ingredients are mixed together and the mixture is grilled for a short time on a skillet or griddle. Food wraps of this type are similar to sandwiches or burritos in terms of contents. Examples of contents are sliced meats, vegetables, cooked eggs, cheeses, and beans, among other edible contents. Usually, the contents are added to a room temperature wrap. The assembled food products may then be served or stored cold, hot, or at room temperature as appropriate based on contents. Rolled up and folded together, the final products have a tubular shape with enclosed ends.

There are also varieties of food wraps that are designed specifically for high-heat cooking as an assembled food product. This is often done by frying the wrap and its assembled contents in oil, baking the wrap and contents together, or putting the assembled food product between two hot grilling surfaces. Examples of some of these wrap varieties are egg rolls and spring rolls. These wraps contain a mixture of sliced meats and vegetables that are often fried before putting into the wrap material. In end product form, these types of comestibles usually have a roughly tubular shape as well. For each of these uses, the present invention is a superior containment design that minimizes excess wrapping material and improves the eating experience.

Taco ingredients and pizza toppings are also suitable contents for wrap-based comestibles. In these applications, the present invention provides a more efficient use of wrap materials while performing the same functions of retaining the contents.

In their initial forms, food wraps for the wrap sandwich type described above are generally round/ovoid or square/ rectangular. The reason for round food wrappers is that the shape is easy to create by hand. There is also a basis for round tortillas by tradition. Historically, after the dough is mixed in a manual process, it is rolled in the hands. Afterward, it is flattened with a roller, with the result being a round or oval shape. As such, the method is often passed down in training within a family. Tradition is an important reason why designs have not improved before this invention.

Besides tradition, another reason for producing a round wrap is that it is easily made mechanically by high-speed machinery or hand-driven rollers. In a mechanized process, a round lump of dough is produced by mixing the ingredients using automatic metering systems. The round lump of dough is then fed through rollers or presses, resulting in a flattened oval or circle. Similarly, prior art pressing machines start with a lump of dough to create a round flat wrap. This step is often followed by cooking the flattened dough in oil baths or on heated conveyor strips.

The circular shape is typical of both the historical and conventional design. It is exemplified by the output of a tortilla-forming machine described by McCarney in U.S. Pat. No. 7,140,864. Another such apparatus is a tortilla-cutting machine described by Lawrence in U.S. Pat. No. 5,918,533. Still another circular tortilla production system is a tortilla-shaping and cooking method defined by Longenecker in U.S. Pat. No. 4,281,025. Still another round tortilla formulation and production method is defined by Skarra et al in U.S. Pat. No. 4,735,811.

For purposes of discussion, the present invention uses the term “tortilla” to represent the soft round form of food containment material. It is obvious that such an item can be created from a variety of food materials such as flour, corn or other ingredients. Furthermore, it could alternatively be square or rectangular.

Square or rectangular wrap structures are often used for egg or spring rolls. These have been employed for centuries in Far-Eastern countries such as Japan and China. An exception to square or round wraps is a heart-shaped tortilla used to produce cone-shaped taco shells as described by Mercenari in U.S. Pat. No. 5,009,902. However, most food wraps have been made from wrap materials initially shaped in conventional round/oval or square/rectangular configurations.

Square or rectangular shaped wraps are cut by hand to shape or produced mechanically using material flow guides or trimmers/cutters. The initial production of basic wrap material follows methods used to produce round/oval wraps. In such cases, a spherical lump of dough is made by mixing the ingredients and then separating out a small section of dough and rolling it. The spherical dough balls are then extruded or fed through rollers and constrained with regard to lateral edges. Automated trimming bars or slicing knives are then often used to produce square leading and trailing edges. This results in a rectangular or square wrap that is fed to the cooking stage. To date, conventional machinery has produced standard shapes of ovals, circles, squares or rectangles, other than Mercenari mentioned above.

Of late, multi-sided food products have been introduced in Mexican-style fast food restaurants. These start with a large circular tortilla filled with appropriate contents. Sections of a large-sized wrap material are then folded over and grilled to seal the assembly together. The result is a volumetric planar arrangement (roughly flat, but with some thickness) instead of the tubular wrap sandwiches described earlier. TACO BELL® purveys such an item under the name of CRUNCHWRAP SUPREME®.

A variety of Italian-style food products is also applicable to this methodology. In such uses, the dough serves as both a base substrate as well as a top covering. The ingredients consist of traditional pizza components such as meats, cheeses, and vegetables. The present invention provides for a more effective use of the dough, saving costs for the producer.

Several problems exist with the conventional round or oval designs in terms of producing wrapped food products. In one implementation, the desired outcome of the final product is a predominantly tubular assemblage 100 of edible contents contained by the wrap device as shown in FIG. 1. This portable food product is usually held in the hands while being consumed. A first problem with the conventional round wrap design is the difficulty in folding wrap material to construct an “end” to a tubular design without having considerable overlapping of material. This is simply because there is more material than is needed to close the end of the tubular assembly. The excess material is therefore folded upon itself and constricted at several points, as illustrated in FIG. 3.

A step-by-step sequence illustrates the nature of the prior art. In FIG. 2, two portions 102 of the circular wrap material opposite each other on a round tortilla are held at about a 90° angle to the plane of the remainder. As an example of contents, sliced or shredded food 107 is then added at this time. The end flap portions 102 are then laid over the tops of the food contents, partially covering the contents. A typical next step is that portion 104 of the round wrap material is then folded over the contents and wrap portions 102, as shown in FIG. 3. Dashed lines 110 show the enclosed hidden edges of areas of folded-in wrap materials 112. The assembly process is completed by folding over the remaining portion of the wrap material 106 to result in the completed assembly 100 as shown in FIG. 1.

Upon visual inspection of FIG. 3, it is apparent that the wrap material near the ends must be constricted. This is necessary to bring the fold-over flap of a circular wrap material into a “closed” or “contained” position. The puckered constrictions 108 occur at numerous locations at each end of the wrapped food product. They are a natural consequence of trying to form a planar circle into an enclosed volumetric tube. Similarly, the material is further constricted by folding over the remaining flap of wrap material 106. There is a resultant overlap of 3 layers of material in sections 112, of which only one layer is required to enclose the contents. The collective percentage of material overlap in these four sections 112 is on the order of 17% as determined by experimental measurements. As such, this material is excessive, of no constructive value, and is often discarded as waste, yielding an inefficient structure.

Similarly with multi-sided food products, the process of folding over a planar circular tortilla into a volumetric polygon results in extensive material overlap. An example of a representative prior art food product is the hexagonal CRUNCHWRAP SUPREME™ 200 from TACO BELL, illustrated in perspective view in FIG. 4. Inspection of a partially completed model in FIG. 5 demonstrates the extent of excess wrap material in this implementation. FIG. 5 illustrates a round tortilla 202 that has had 3 folds and is partially assembled. The figure shows a center folded section 204 that is in its final position in relation to the adjacent folded sections. It is apparent by noting the extent of overlap shown by hidden lines 206 that this folding process produces 3 layers of material in an area only slightly less than the upper surface area of the hexagon. As before, a single layer of tortilla material on the top would be sufficient to contain the ingredients. Allowing for the thickness of contents, empirical calculations show an excess quantity of about 45% of tortilla wrap material. This is the amount that is unnecessary for containing the internal contents but occurs using standard folding techniques.

With the tubular end product configuration, a first problem with using the round wrap material is the difficulty of assembly by the food worker. This difficulty is due to the process of folding a round planar object into the shape of an enclosed tube or volumetric polygon. After adding edible contents, the wrap material is folded in toward the middle to keep the contents from being forced out the ends of the finished wrap when the sides are folded over. While the process can be learned, the wrap material design makes the process more difficult than it need be.

Another problem is the lack of value assigned by consumers to the wadded wrap materials at the ends of the food product. Generally, although it is edible, the wrap material itself is of secondary interest to consumers. Many consumers view the wrap merely as a convenience for holding the better-tasting and more nutritious contents. Collecting more of the wrap material at the end due to the wadding and folding process makes this portion less appetizing. Since a food producer's objective is to make his products more appealing, not less, this side effect of the folding process is counter-productive.

There is yet another consequence of the over-folding process with circular or square wraps. This negative side effect is that this excess wrap material at the ends is often thrown away instead of being eaten. The impact of this effect is an increase to landfill content with its concomitant requirement of collection and conveyance to the landfills. While relatively small, the burden is borne by restaurants, consumers and garbage collectors and is collectively wasteful and unnecessary.

Perhaps the most important consequence of this over-folding process is the waste of otherwise usable materials. The percentages of wrap material associated with the overlapped folds that are unnecessary for containment are significant. Furthermore, once disposed of, this excess material is no longer available for either human or, in many countries, animal consumption. This waste raises the overall cost of the wrap products for the producer and ultimately for the consumer. Depending on final product configuration, the amount of excess materials ranges from at least 15% for a tubular wrap sandwich to about 45% for a hexagonal wrap food product. The alternative perspective is that there is a significant opportunity for materials cost savings for wrap food product producers.

When producing wrap sandwich or egg roll style products, similar problems exist for square and rectangular wrap materials as they do for round/oval wrap materials using conventional designs. With the similar objective of producing a tubular final food product, the end portions become wadded up in the folding process, as illustrated in FIGS. 6-8. The folding process begins similarly to that done with the round wrap material. It begins by turning up two sides 302 of a square or rectangle as shown in FIG. 6 and then adding the food contents (not shown). Sides 304 and 306 are flat in this view. FIG. 7 shows the initial constriction of end materials 308 caused by folding side 304 up. Dashed lines 310 show the enclosed hidden edges of overlap areas of folded-in wrap materials 312. The puckering of wrap materials 308 continues with closure of the remaining side 306 of the wrap material. The resultant product 300 is seen in FIG. 8, shown with constricted areas 308.

The problems with square and rectangular wrap materials are the same as those of round or oval wraps. Firstly, material is folded over and overlapped at the ends of the roughly tubular final assembly in a sequenced handling process. Secondly, this excess material is less desirable for eating and is therefore often thrown away instead of being eaten. This places a burden on restaurants and contributes to landfills. Finally, wasted materials decrease the ratio of end products to raw materials, thereby causing higher costs than necessary for final products.

These problems exist both for standard tortilla-like wrap materials as well as egg roll or spring roll wrapping materials and other dough-based substrates and coverings. With such types of wrap materials, the folding process is more difficult than it needs to be. Furthermore, it produces a constriction of excess wrap materials in addition to being an inefficient use of those materials.

Accordingly, a need exists for an improved and efficient food wrap structure. Such structures make wrap-based comestibles, spring rolls, and other handheld food products easier to assemble and less expensive by using less wrap material to enclose the same volume of contents.

### BRIEF SUMMARY OF THE INVENTION

It is therefore an advantage of the present invention to provide an improved structural design for food wraps that more efficiently encloses the food material by reducing the amount of excess wrap material in key locations. Another advantage is that the present invention simplifies the assembly process by minimizing the amount of material constriction around various sections of the assembled food product. Coincident with this reduction in materials is a reduction in calories for the final food product.

Another advantage of the present invention is that it allows use of the formerly excess portions of the wrap material by separating them from the main body of the wrap prior to cooking. This increases the quantity of wraps that can be produced overall from the same amount of raw materials. A major benefit is the concomitant reduction in production costs for the wrap manufacturer. Any method by which the final embodiment of the wrap design is formed, such as molding, cutting, trimming or extruding, is acceptable.

Another advantage of the present invention is that it facilitates re-use of the formerly excess portions of the wrap material. One re-use method is to cook and package these pieces appropriately as chip-like morsels for conveying salsa, small pieces of fruit or other food mixtures. These chip-like sections can also be coated with flavorings for sale and consumption and eaten separately. The increase in produced goods from the same amount of raw materials is financially advantageous to a food wrap producer.

Another advantage of the present invention is that it promotes or inhibits retention of fluids for the contained food materials chosen. This is accomplished through variation of dimensions of specific sections of the wrap material.

Yet another advantage of the present invention is that the reduced layering of wrap material promotes more even heating or chilling of internal contents once assembled. It is desirable for fast-food producers to heat or cool internal ingredients with the least amount of energy.

Another advantage of the present invention is that it provides different volumetric polygonal embodiments for producing alternatively shaped food products.

It is a further advantage of the present invention that it provides embodiments that enclose either both ends of tubular wrap food products or just one end, depending on the preference of the producer. In each case, a more effective and cost-efficient product is constructed by saving wrap material.

In one embodiment, the wrap of the present invention is an edible food wrap with a substantially circular-shaped outside perimeter. The more-efficient food wrap is substantially symmetrical over a vertical center line defining a left-hand portion and a right-hand portion. The wrap has at least two approximately semicircular voids that comprise excess material when wrapped. There is a first semicircular void formed in the right-hand portion that includes a first curved portion of the outside perimeter. There is also a second semicircular void formed in the left-hand portion that includes a second curved portion of the outside perimeter. The first semicircular void and the second semicircular void are substantially symmetrical over the vertical center line.

In one embodiment, the edible wrap is formed from at least one of wheat flour and corn flour.

In another embodiment, the first curved portion of the first semicircular void and the second curved portion of the second semicircular void are concave with respect to the outside perimeter.

In still another embodiment, the wrap of the present invention is an edible food wrap with a substantially circular-shaped outside perimeter and four approximately semicircular voids. It is substantially symmetrical over a vertical center line defining a left-hand portion and a right-hand portion. The edible wrap is also substantially symmetrical over a horizontal center line defining a top right-hand portion and bottom right-hand portion and a top left-hand portion and a bottom left-hand portion. A first semicircular void is formed in the bottom right-hand portion that includes a first curved portion of the outside perimeter. A second semicircular void is formed in the bottom left-hand portion that includes a second curved portion of the outside perimeter such that the first semicircular void and the second semicircular void are substantially symmetrical over the vertical center line. A third semicircular void is formed in the top right-hand portion that includes a third curved portion of the outside perimeter. A fourth semicircular void is formed in the top left-hand portion that includes a fourth curved portion of the outside perimeter such that the third semicircular void and the fourth semicircular void are substantially symmetrical over the vertical center line.

In still another embodiment, the first semicircular void and the third semicircular void are substantially symmetrical over the horizontal center line and the second semicircular void and the fourth semicircular void are substantially symmetrical over the horizontal center line.

In another embodiment, the first, second, third and fourth approximately semicircular voids are each concave with respect to the outside perimeter.

In still another embodiment, the wrap reduces the overall wrap material by removing additional material around each formed void. The voids formed approximate semicircles but are not exact semicircles geometrically. The purpose of this inexactitude is to allow fluids from contents to be drained more easily than otherwise. The removed material is located adjacent to and falling outside the prescribed arc of the approximately semicircular voids formed as part each void.

In still another embodiment, the overall wrap is not reduced as much as previously. This is done by retaining additional material around each formed void. The additional material is located adjacent to and falling inside the prescribed arc of the approximately semicircular voids that are formed as part each void. In this case, fluidic contents are retained better than other designs while still saving wrap materials overall.

In another embodiment, the wrap of the present invention is a more-efficient food wrap with a substantially rectangular-shaped outside perimeter. The wrap is substantially symmetrical over a vertical center line defining a left-hand portion with a left bottom corner and a right-hand portion with a right bottom corner. It has at least a first rectangular void formed in the bottom right corner along a portion of the outside perimeter and a second rectangular void formed in the left bottom corner along a portion of the outside perimeter. This first rectangular void and the second rectangular void are substantially symmetrical over the vertical center line. The formed voids may have curved corners for purposes of fluid retention or release, explained below.

In yet another embodiment, the edible food wrap has a substantially rectangular-shaped outside perimeter. The wrap is substantially symmetrical over a vertical center line defining a left-hand portion and a right hand portion. It is also substantially symmetrical over a horizontal center line defining a left-hand portion with a bottom left corner and a top left corner and a right-hand portion with a bottom right corner and a top right corner. This food wrap has multiple rectangular voids formed in the corners along portions of the outside perimeter. These voids have either sharp or curved corners depending on the producer's needs for fluidic contents retention or release. It has at least a first rectangular void formed in the bottom right corner, a second rectangular void formed in the bottom left corner, a third rectangular void formed in the top right corner, and fourth rectangular void formed in the top left corner. The first rectangular void and the second rectangular void are substantially symmetrical over the vertical center line. Also, the third rectangular void and the fourth rectangular void are substantially symmetrical over the vertical center line.

In another embodiment, the first rectangular void and the third rectangular void are substantially symmetrical over the horizontal center line and the second rectangular void and the fourth rectangular void are substantially symmetrical over the horizontal center line.

In yet another embodiment, there is a more-efficient edible food wrap with a substantially circular-shaped outside perimeter. This embodiment includes at least a first approximately triangular void formed in the wrap material at the perimeter. One vertex of this triangular void is oriented toward the center of the circular-shaped wrap. This most-central vertex of this void is no closer to the geometric center of the wrap than one-half the radial distance of the wrap as measured from the geometric center of the wrap to the curved line of its outside perimeter.

In another embodiment, the edible food wrap has multiple approximately triangular voids formed in the wrap material. These voids are uniformly arrayed around the curved perimeter. Each void has a most-central vertex oriented toward the center of the circular-shaped wrap, such that the distal vertices of these triangular voids are formed at or near the distal vertices of adjacent triangular voids.

In yet another embodiment, the edible food wrap has numerous approximately triangular voids in which the sides of the triangular voids adjacent to the most-central vertices are formed along curved lines between these most-central vertices and distal vertices. In this embodiment, the curved lines of the triangular voids are outside the shape represented by straight sides of a standard triangle, increasing the size of the voids. As with other embodiments, this facilitates the release of fluidic contents.

In still another embodiment, the edible food wrap has numerous triangular voids in which the sides of the triangular voids adjacent to the most-central vertices are formed along curved lines between these most-central vertices and distal vertices. In this embodiment, the curved lines of the triangular voids are formed inside the shape represented by straight sides of a standard triangle, reducing the size of the voids. This increase in wrap material has the effect of better retention of fluidic contents.

In yet another embodiment, an additional edible wrap element is added to the food product to provide a surface against which folded-over sections may adhere.

These and other advantages of the present invention will become apparent from the following description.

### BRIEF DESCRIPTIONS OF THE SEVERAL VIEWS OF THE DRAWING

FIG. 1 is an illustration of a prior art tubular food product made from a round tortilla wrap material.

FIGS. 2 and 3 demonstrate the assembly steps in producing the prior art tubular food product of FIG. 1.

FIGS. 4-5 show a representative prior art volumetric polygonal food end-product and the nature of overlapping wrap materials resulting from the assembly process.

FIGS. 6-7 demonstrate the prior art assembly steps in producing a tubular food product from a square or rectangular wrap material.

FIG. 8 is an illustration of a substantially tubular prior art food product assembled using the process shown in FIGS. 6 and 7.

FIG. 9 is a diagram according to the present invention of an improved more-efficient wrap structure derived from a substantially-circular wrap material.

FIG. 10 shows how the improved wrap structure can be made from a standard round/oval tortilla or substantially-circular wrap material.

FIGS. 11 and 12 demonstrate the assembly steps in producing a tubular food product using a substantially-circular improved wrap structure according to the present invention.

FIG. 13 is the tubular food product resulting from the assembly steps shown in FIGS. 11 and 12.

FIGS. 14 through 17 show variations in specific portions of an improved wrap structure to accommodate a potential producer's preferences based on contents.

FIG. 18 is a diagram of an improved round wrap embodiment designed for one open end of a handheld food product.

FIG. 19 is a diagram of a handheld food product with one open end assembled from an improved round wrap embodiment.

FIG. 20 is a diagram according to the present invention of a more-efficient improved wrap structure derived from a substantially-square wrap material.

FIGS. 21 and 22 demonstrate the assembly steps in producing a tubular food product using a substantially-square improved wrap structure according to the present invention.

FIG. 23 is the tubular food product resulting from the assembly steps shown in FIGS. 21 and 22.

FIGS. 24 and 25 show variations in specific portions of an improved square wrap structure to accommodate a potential producer's preferences based on contents.

FIG. 26 is a diagram of an improved square wrap embodiment designed for one open end of a handheld food product.

FIG. 27 is a diagram of one example of a completed square wrap food product with one end open according to the present invention.

FIG. 28 is a diagram of a sample multi-sided wrap embodiment with numerous voids that is used to create a volumetrically planar or disc-like food product.

FIG. 29 shows an embodiment with void formations that reduces the amount of wrap material being folded over, exposing more internal contents in the final product.

FIG. 30 shows an embodiment with void formations that increases the amount of wrap material being folded over, exposing less internal contents in the final product.

FIGS. 31 through 34 demonstrate the assembly steps in producing a sample hexagonal food product using a circular wrap structure with numerous triangular voids forming a six-pointed wrap structure according to the present invention.

FIGS. 35 and 36 show variations in specific portions of the sample six-pointed wrap structure to accommodate a potential producer's preferences based on contents.

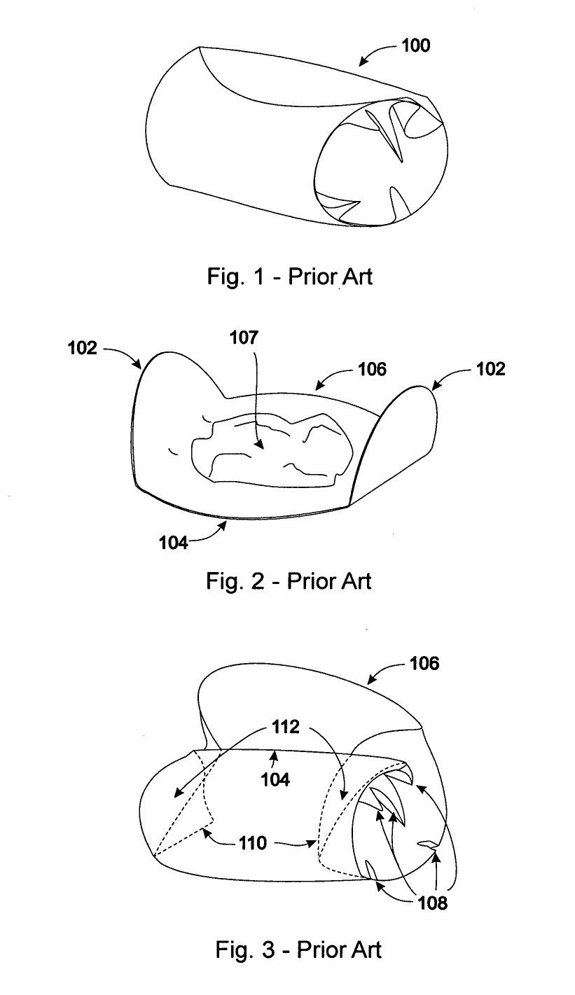

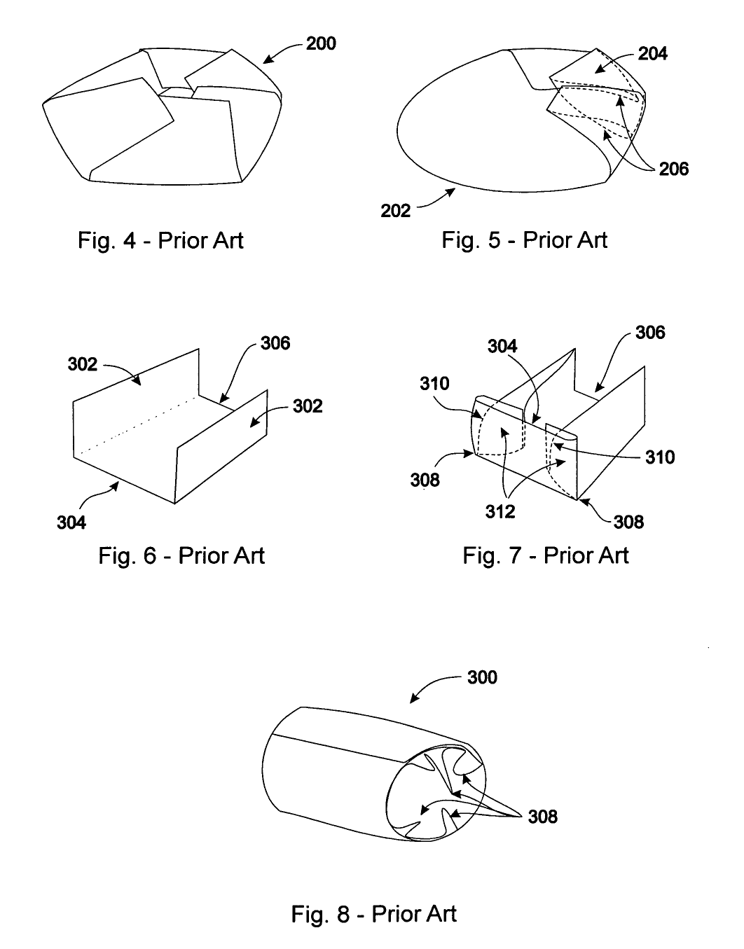

### DETAILED DESCRIPTION OF THE INVENTION

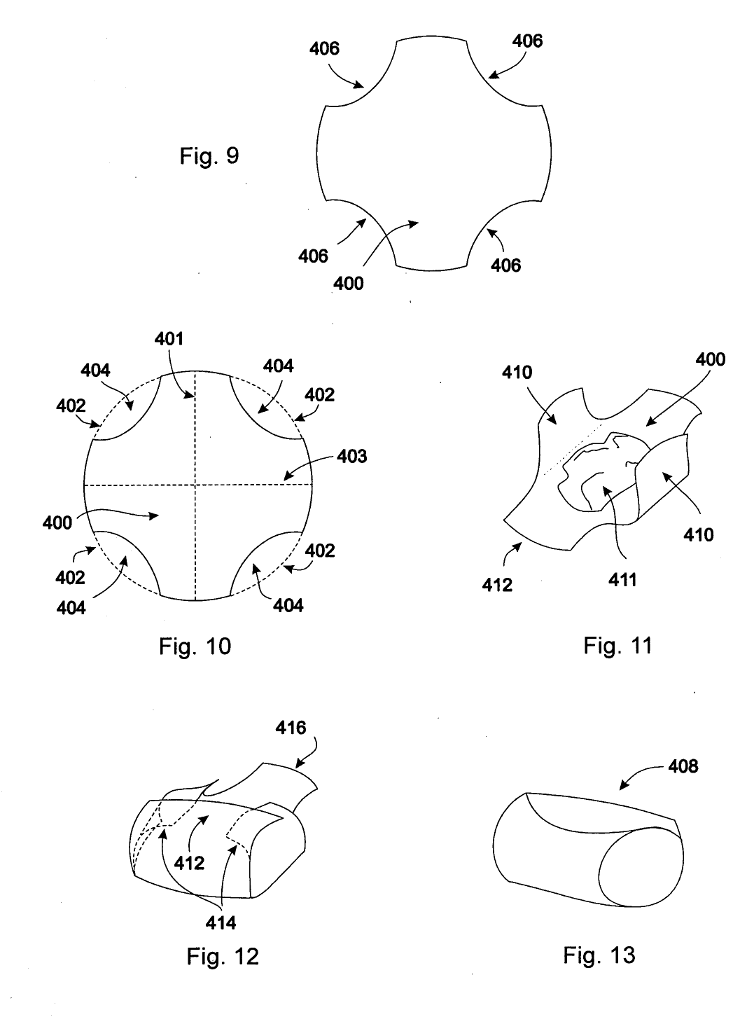

The first preferred embodiment derives its structure from a circular wrap material. FIG. 9 is the plan view of this improved design 400 with voids formed along lines 406. This structure is most useful for forming a tubular handheld food product. FIG. 10 illustrates differences between the present invention and a comparative prior art circular food wrap or tortilla. With dotted lines 402 indicating the full circle of an ordinary circular material, the present invention has voids 404 that have been formed through molding, cutting or trimming actions. A vertical line 401 in this figure illustrates that the present invention is roughly symmetrical between right and left sides. Similarly, a horizontal line 403 is drawn in the figure to show that the top and bottom halves are also roughly symmetrical. Upon forming the voids, the materials that ordinarily would have been part of a complete circle of wrap material are therefore available for other uses, as described earlier. The new design without these voids is also more conducive to assembly with reduced fold-over waste.

FIGS. 11-13 show a representative assembly process for a roughly tubular food product 408. It is called “roughly” tubular because of the difficulty of forming an exact cylindrical structure with soft pliable materials. This process demonstrates only one way, and not the only system, for assembling such a food product. The process can be accomplished either manually by hand or through automated machines. Starting with the wrap material 400 as shown in FIG. 11, two sections 410 are held at approximately a 90° angle to the plane of the remainder. These are sections that will become “ends” of an assembled tubular-shaped food product. Examples of food contents 411 are added and these end sections 410 are laid over the top of the contents. FIG. 12 illustrates a typical next step in that portion 412 of the round wrap material is then folded over the contents and the “end” sections 410. Dashed lines 414 show the enclosed hidden edges at the ends of the folded-over wrap material. The assembly process is completed by folding over the remaining portion of the wrap material 416 to result in the completed assembly 408 as shown in FIG. 13.

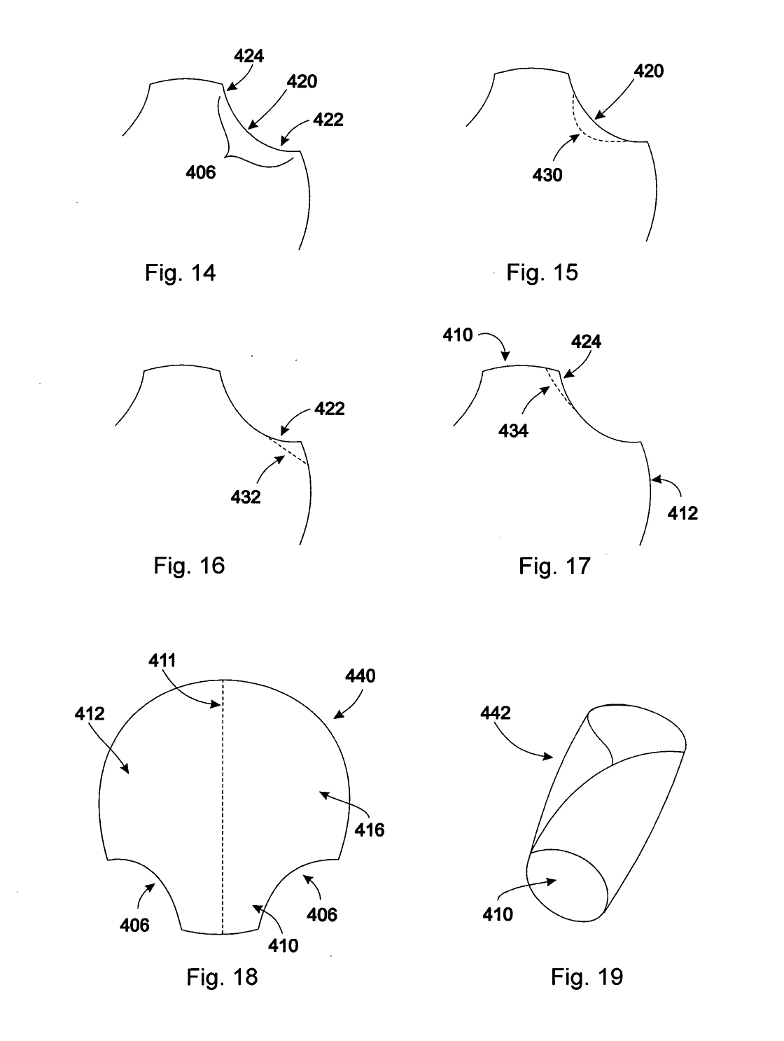

Additional details are found by referring to a single quadrant of the whole wrap as an example shown in FIG. 14. In this figure, there are at least 3 subsections of edges 406 whose shapes are important to their functions. The exact dimensions and angles of these subsections vary based on the specific functions. The purpose of material bounding subsection 420 is to retain contents and either retain or release internal fluids of the contents at corner fold regions of the wrapped food product. Material bounding subsection 422 provides for lateral retention of contents when side flaps 412 and 416 have been folded over in final position. Subsection 424 material bounds the end portion 410 of the wrap material that provides the primary holding force under the side flaps 412 and 416 of FIG. 12 after assembly.

A first purpose of material bounding subsection 420 is to hold in the edible contents. As such, it must provide sufficient overlap of wrap material in the final assembled form to provide little to no opening, depending on content materials. A second purpose is to either hold in fluids or release them. Retention or release of fluids is seen by referring to FIG. 15. If the food producer's purpose is to release fluid contents, the food producer would approximately follow cutout line 430 of subsection 420 to provide less overlap coverage at corners than the initial wrap configuration. The folding process results in small holes appearing at these corner fold locations out of which fluids can drain. If instead the producer's purpose is to retain fluidic contents along with solid contents, subsection 420 in its original form provides sufficient overlap. This overlap eliminates holes in these locations of the final assembled food product once all sides are folded over.

Material bounding subsection 422 has as its purpose to retain the solid contents. The width of material bounded by subsection 422 is therefore dependent on the approximate volume of solid contents. The greater the volume of contents, the less overlap of wrap materials there will be, resulting in lower lateral retention forces. Assuming that a standardized food product is desired, a producer determines the most effective enclosing dimensions based on standard content volumes. The producer applies these dimensions to the wrap material substrate during its manufacture. Alternatively, the excess material can be removed by hand at the time of food product assembly, recycling material as desired. Referring to FIG. 16, side flap material could be removed following edge 432 to yield further wrap material savings assuming this removal accommodated content sizes and provided sufficient lateral retention force.

Material bounding subsection 424 is folded over the contents prior to folding of the side flaps. Collectively, materials between sections 424 constitute the “end” flaps (410 from FIG. 11) of the tubular food product 408. In FIG. 17, the width of end flaps 410 can be reduced along edge lines 434 to save yet more wrap material, depending on volume of contents. This embodiment efficiently reduces overlap material at the sides of the end flap. As discussed earlier, the primary holding force is provided by lateral resistance due to overlap of side flaps 412 and 416 (not shown in FIG. 17) as well as external pressures applied by holding the food product in hand. Optionally, toothpicks through these end sections 410 and flaps 412 and 416 or binding agents provide definitive retention.

FIG. 18 is an embodiment of an improved round wrap structure 440 designed for one open end of a tubular-shaped food product. As with structure 400 in FIG. 9, voids are formed in the wrap material along lines 406. A vertical line 411 is drawn to illustrate that the left and right halves are roughly symmetrical across the vertical axis as drawn. Assembly of a food product would follow procedures as described previously. In these, end flap 410 is folded over contents and then side flaps 412 and 416 are folded over, enclosing the contents. The completed version of such a product is drawn in FIG. 19. Food contents are not shown in these two drawings.

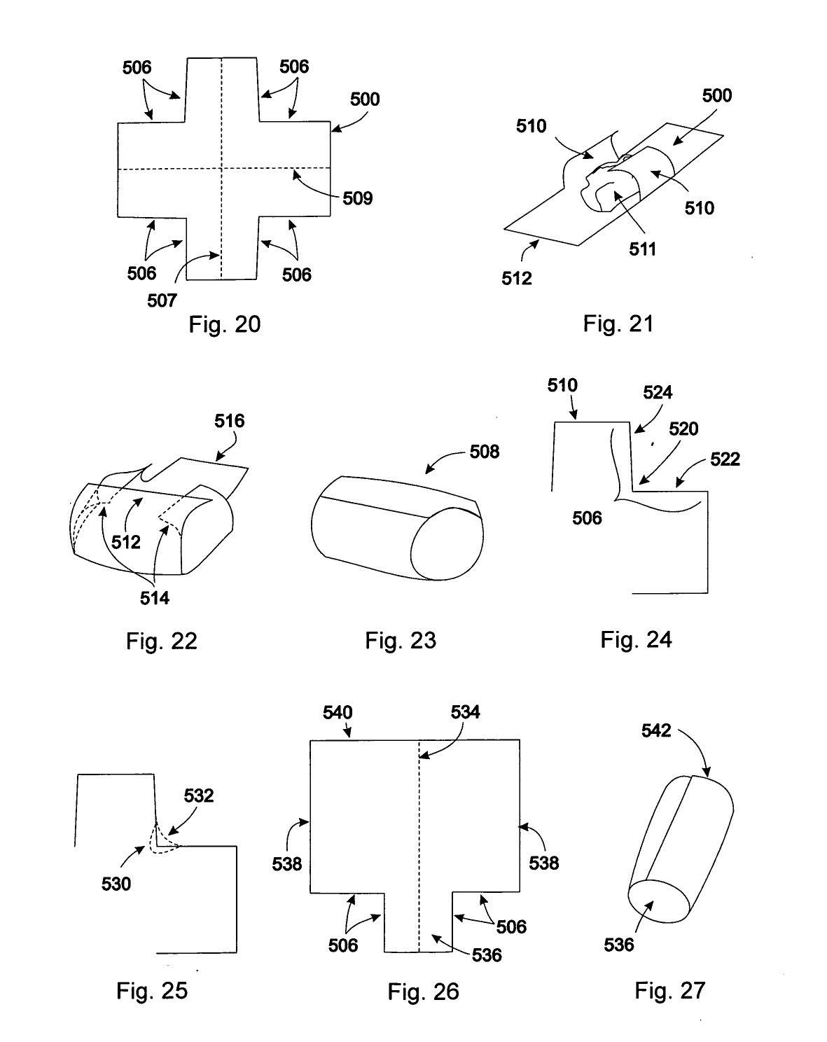

The second preferred embodiment is based on construction of a roughly tubular food product using a square wrap material. FIG. 20 is the plan view of this improved structure 500 with voids formed along lines 506. As with the improved circular wrap model, the voids can be formed by molding, cutting or trimming actions. There is therefore a similar savings due to reduction in the quantity of ingredients needed to make the end result, a tubular hand-held food product. Another characteristic of this family of improved wrap structures is ease of assembly.

FIGS. 21-23 show a representative assembly process for a tubular food product 508 that is similar in final form to one which employs a circular wrap material shape. Starting with the wrap material 500 as shown in FIG. 21, two end sections 510 are initially held at approximately a 90° angle to the plane of the remainder. Examples of food contents 511 are added and these end sections 510 are draped over the top of the contents. A typical next step as shown in FIG. 22 is that portion 512 of the square wrap material is then folded over the contents (not shown in this figure). Dashed lines 514 show the enclosed hidden edges of the folded-in wrap material of end sections 510. The assembly process is completed by folding over the remaining portion of the wrap material 516 to result in the completed assembly 508 as shown in FIG. 23.

As with the round wrap material, there are key portions of the square wrap material whose dimensions provide specific utility. Referring to a single quadrant of the wrap as an example shown in FIG. 24, there are at least 3 subsections of void edges 506 whose shapes are related to their functions. The exact dimension and curvature of these shapes vary based on the intended functions. The purpose of material bounding subsection 520 is to retain contents and either retain or release internal fluids of the contents at corner fold regions of the wrapped food product. As with the round wrap material, material bounding subsection 522 provides for lateral retention of contents when side flaps 512 and 516 have been folded over in final position. Subsection 524 bounds the end portion of the wrap material that provides the primary holding force under the side flaps after assembly.

A first purpose of material bounding subsection 520 is to hold in the edible contents. As such, it must provide sufficient overlap of wrap material in the final assembled form to provide little to no opening. A second purpose is to either hold in fluids or release them. In FIG. 25, if the producer's purpose is to release fluid contents, the food producer would approximately follow cutout line 530 of subsection 520 to provide less overlap coverage than the initial sharp-cornered design. The folding process results in small holes appearing at corner fold locations out of which fluids can drain. If instead the producer's purpose is to retain fluidic contents along with solid contents, cutout line 532 provides increased overlap. This overlap eliminates holes in these locations of the final assembled food product once all sides are folded over.

Material bounding subsection 522 in FIG. 24 has as its purpose to retain the solid contents. The width of material bounded by two subsection lines 522 is therefore dependent on the approximate volume of solid contents. Assuming that a standardized food product is desired, a producer determines the most effective enclosing dimensions based on regular content volumes. The producer applies these dimensions to the wrap material substrate during its manufacture.

Material adjoining subsection 524 in FIG. 24 is adjacent to end sections 510, which are folded over the contents prior to folding of the side flaps. The width of the sections abutting subsection 524 is therefore either increased or decreased to accommodate the contents. Since this embodiment efficiently reduces overlap material at the sides of the end flap, the primary holding force is provided by lateral resistance due to overlap of side flaps 512 and 516 (as shown in FIG. 22). Additional holding forces occur from external pressures applied by holding the food product in the hand. Optionally, toothpicks through these end section 510 materials and flaps 512 and 516 or binding agents provide definitive retention.

As with the circular wrap material, a square wrap may be employed to create wrap sandwiches that have one end open. In such a case, a wrap structure 540 as shown in FIG. 26 with only one end having 506 voids is consistent with the present invention. A vertical line 534 is drawn to illustrate that the left and right halves are roughly symmetrical across the vertical axis as drawn. To assemble this design, end flap 536 is folded over contents and then side flaps 538 are sequentially folded over, enclosing the contents. The completed version of such a product 542 is drawn in FIG. 27 with the end flap 536 shown toward the bottom. Food contents are not shown in this drawing. The formed voids minimize or eliminate puckering at fold-over corners, as with other embodiments. Similar to the circular wrap design with voids of the present invention, this design also saves wrap material for other uses.

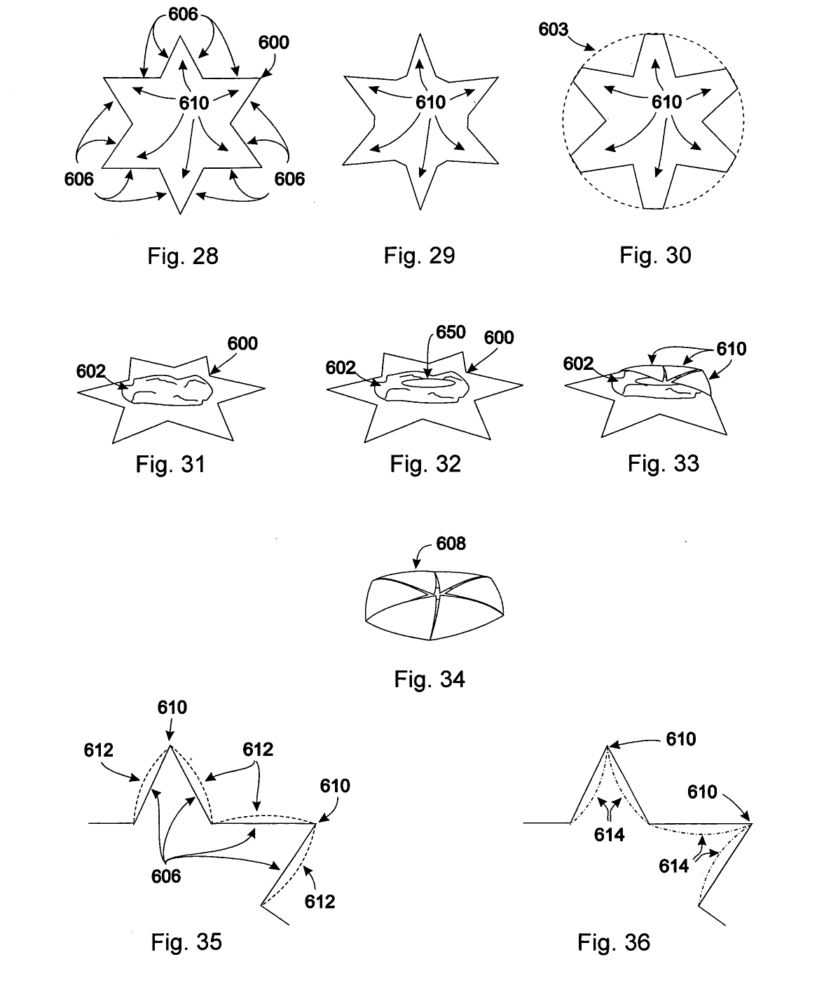

A third preferred embodiment according to the principles of this invention uses an initially round tortilla wrap material to produce a disc-like polygonal food product. For the purposes of explanation, a hexagonal end product is used in further discussion. It should be readily apparent that other end-product polygonal shapes are equally suitable for purposes of the present invention. Examples of such polygons include triangles, squares, and pentagons, among others. FIG. 28 is the plan view of a sample 6-section improved wrap structure 600 with voids formed along lines 606, creating six pointed sections 610. As with the other embodiments, the voids can be formed by molding, cutting or trimming actions. The resultant wrap yields a food product that has the same appearance as current consumer products but uses less wrap material. There is therefore a significant savings due to reduction in the quantity of ingredients needed to make the end result, a hand-held food product. Another characteristic of this family of improved wrap structures is ease of assembly.

FIG. 29 illustrates a variation on the sample 6-pointed structure that reflects increased void formations of near-triangular shape. The smaller (less wide) pointed sections 610 of FIG. 29 cover less of the contents when folded over. As with FIG. 28, the initial wrap shape starts as a circle, and then voids are formed to create a multi-pointed shape. A further variation on a sample 6-pointed structure is shown in FIG. 30. This initial circular shape is illustrated by dotted line 603. The wider pointed sections 610 of FIG. 30 cover more of the food contents when folded over. The choice of covering or exposing food contents in a finished food product is based on production preferences of the food producer.

FIGS. 31-34 show an example of an assembly method for a volumetric hexagonal food product 608. Beginning with an approximately round wrap material, voids are formed to create a sample 6-sectioned star-shaped wrap material 600 as shown in FIG. 28. With wrap material 600 laid flat, food contents 602 are placed into the middle portion of the wrap as shown in FIG. 31. If used, an optional internal contents-constraining material 650 is then laid on top of the edible contents as illustrated in FIG. 32. For purposes of this invention explanation, this contents-constraining material 650 is described as if included. The choice of inclusion of material 650 belongs to the food producer and is based on advantages. This constraining material can take the form of a circle, another multi-pointed star shape, or another shape, and it is made of either soft or hard tortilla materials. This constraining material has a much smaller circumference than the primary wrap material. In the case in which a multi-pointed star shape constraint material is used, the pointed sections are aligned with the sections 610 of the primary wrap material. The order in which sections 610 are folded over is not critical. Small amounts of a binding agent such as cheese or a flour-based paste (not shown) are then applied as desired by the producer to locations on the constraint material 650. The purpose of this binding agent is to hold sections 610 down after folding over. FIG. 33 shows a partially-completed food product with a representative three sections 610 folded over. After assembly, the food product is a volumetric disc-like food product 608 with the thickness of its contents and the folded-over wrap materials, as drawn in FIG. 34. Some producers will choose to placed the assembly in a press or similar device or have a weight applied and be further heated as desired.

The use of the constraint material 650 is optional. If it is not employed, sections 610 are still folded over, and pressure, heat, or other techniques or devices are used to hold the assembly together.

As with the other improved wrap products, there are key portions of the wrap material whose particular dimensions provide specific utility. See FIGS. 35-36 for details. The curvature of edge 606 determines the extent of overlap between adjoining sections 610, allowing a variable amount of exposure of the internal food contents Referring to FIG. 35, two adjoining sections 610 and their edges 606 are illustrated. Edges 606 may be expanded outwardly by reducing the size of the formed voids along lines 612 to increase the amount of overlap between adjacent sections 610 upon folding. This slightly increases the amount of wrap material employed but can eliminate the need for optional constraint material 650 depending on the binding properties of the internal contents. This implementation provides full covering of the internal food contents through overlap of the folded-over sections 610. By the same token, removing additional material by expanding the formed void to form a shape that follows curve 614 in FIG. 36 provides increased exposure of the internal food materials. This is desirable for use with pizza-style products or some dessert items. Alternatively, edges 606 may be straight lines that meet at the junction of other lines along edge 606 of adjoining sections 610. The exact shape is determined by the purposes of the food producer. In the method of the present invention, there is no limitation to the angle of curvature or number of folding sections employed. It could reasonably be made with three, four, five, or more formed voids to suit purposes of the food producer.

There is an almost unlimited number of combinations of contents, lengths, girths, and cross-sectional areas possible in producing a roughly tubular or volumetric planar food product according to this invention. The final design is dependent on a food producer's purposes for a given product and the amount of wrap material that the producer desires to save or reuse. As such, it is apparent that exact dimensional details of a final wrap structure meeting these general purposes cannot be specified. Many variations of dimensions satisfy the descriptions herein.

While considerable emphasis has been placed on the preferred embodiments of the invention illustrated and described herein, it will be appreciated that other embodiments can be made and that many changes can be made in the preferred embodiments without departing from the principles of the invention. Accordingly, it is to be distinctly understood that the foregoing descriptive matter is to be interpreted merely as illustrative of the invention and not as a limitation. I claim:

1. A wrap comprising:
an edible food wrap with a substantially circular-shaped outside perimeter and that is substantially symmetrical over a vertical center line defining a left-hand portion and a right-hand portion and
at least a first approximately semicircular void formed in the right-hand portion that includes a first curved portion of the outside perimeter and
a second approximately semicircular void formed in the left-hand portion that includes a second curved portion of the outside perimeter such that the first semicircular void and the second semicircular void are substantially symmetrical over the vertical center line.

2. The wrap of claim 1, wherein the edible wrap is formed from at least one of wheat flour and corn flour.

3. The wrap of claim 1, wherein the first curved portion of the first semicircular void and the second curved portion of the second semicircular void are concave with respect to the outside perimeter.

4. A wrap comprising:
an edible food wrap with a substantially circular-shaped outside perimeter and
that is substantially symmetrical over a vertical center line defining a left-hand portion and a right-hand portion and
that is substantially symmetrical over a horizontal center line defining a top right-hand portion and bottom right-hand portion and a top left-hand portion and a bottom left-hand portion;
at least a first approximately semicircular void formed in the bottom right-hand portion that includes a first curved portion of the outside perimeter and
a second approximately semicircular void formed in the bottom left-hand portion that includes a second curved portion of the outside perimeter such that the first semicircular void and the second semicircular void are substantially symmetrical over the vertical center line; and
at least a third approximately semicircular void formed in the top right-hand portion that includes a third curved portion of the outside perimeter and
a fourth approximately semicircular void formed in the top left-hand portion that includes a fourth curved portion of the outside perimeter such that the third semicircular void and the fourth semicircular void are substantially symmetrical over the vertical center line.

5. The wrap of claim 4, wherein the first semicircular void and the third semicircular void are substantially symmetrical over the horizontal center line and the second semicircular void and the fourth semicircular void are substantially symmetrical over the horizontal center line.

6. The wrap of claim 4, wherein the first curved portion of the first semicircular void, the second curved portion of the second semicircular void, the third curved portion of the third semicircular void, and the fourth curved portion of the fourth semicircular void are concave with respect to the outside perimeter.

7. The wrap of claim 4, wherein additional wrap material adjacent to and falling outside the prescribed arc of the semicircular voids is removed from the wrap and formed as part of the void to increase the size of the void.

8. The wrap of claim 4, wherein additional wrap material adjacent to and falling inside the prescribed arc of the semicircular voids is added to the body of the wrap and formed as part of the void to reduce the size of the void.

9. The wrap of claim 4, wherein the edible wrap is formed from at least one of wheat flour and corn flour.

10. A wrap comprising:
an edible food wrap with a substantially rectangular-shaped outside perimeter and
that is substantially symmetrical over a vertical center line defining a left-hand portion with a left bottom corner and a right-hand portion with a right bottom corner and
at least a first rectangular void formed in the right bottom corner along a portion of the outside perimeter and
a second rectangular void formed in the left bottom corner along a portion of the outside perimeter such that the first rectangular void and the second rectangular void are substantially symmetrical over the vertical center line.

11. The wrap of claim 10, wherein the edible wrap is formed from at least one of wheat flour and corn flour.

12. A wrap comprising:
an edible food wrap with a substantially rectangular-shaped outside perimeter and that is substantially symmetrical over a vertical center line defining a left-hand portion and a right-hand portion and
that is substantially symmetrical over a horizontal center line defining a left-hand portion with a bottom left corner and a top left corner and a right-hand portion with a bottom right corner and a top right corner and at least
a first rectangular void formed in the bottom right corner along with a portion of the outside perimeter and
a second rectangular void formed in the bottom left corner along a portion of the outside perimeter such that the first rectangular void and the second rectangular void are substantially symmetrical over the vertical center line;
a third rectangular void formed in the top right corner along a portion of the outside perimeter and
a fourth rectangular void formed in the top left corner along a portion of the outside perimeter such that the third rectangular void and the fourth rectangular void are substantially symmetrical over the vertical center line.

13. The wrap of claim 12, wherein the first rectangular void and the third rectangular void are substantially symmetrical over the horizontal center line and the second rectangular void and the fourth rectangular void are substantially symmetrical over the horizontal center line.

14. The wrap of claim 12, wherein the edible wrap is formed from at least one of wheat flour and corn flour.

15. A wrap comprising:
an edible food wrap with a substantially circular-shaped outside perimeter and
that includes at least a first approximately triangular void formed in the wrap material at the perimeter with one vertex of said triangular void oriented toward the center of said circular-shaped wrap, such that said most-central vertex of said void is no closer to the geometric center of said wrap than one-half the radial distance of said wrap as measured from the geometric center of said wrap to the curved line of its outside perimeter.

16. The wrap of claim 15, wherein there are multiple approximately triangular voids formed in the wrap material and
wherein said voids are uniformly arrayed around the curved perimeter, each of said voids having a most-central vertex oriented toward the center of the circular-shaped wrap, such that the distal vertices of said triangular voids are formed at or near the distal vertices of adjacent triangular voids.

17. The wrap of claim 15, wherein the sides of said triangular voids adjacent to said most-central vertices are formed along curved lines between said most-central vertices and said distal vertices, wherein said curved lines are outside the shape represented by straight sides of a standard triangle, increasing the size of said triangular voids.

18. The wrap of claim 15, wherein the sides of said triangular voids adjacent to said most-central vertices are formed along curved lines between said most-central vertices and said distal vertices, wherein said curved lines are inside the shape represented by straight sides of a standard triangle, decreasing the size of said triangular voids.

19. The wrap of claim 15, wherein the sections remaining after forming voids are folded over to retain food contents and adhered to an additional edible wrap element.

20. The wrap of claim 15, wherein the edible wrap is formed from at least one of wheat flour and corn flour.
